(19) United States
(12) Patent Application Publication
(10) Pub. No.: US 2014/0146154 A1
(43) Pub. Date: May 29, 2014

(54) PATIENT MONITORING SYSTEM WITH IMAGE CAPTURE FUNCTIONALITY

(71) Applicant: Basil C Bautovich, Australian Capital Territory (AU)

(72) Inventor: Basil C Bautovich, Australian Capital Territory (AU)

(73) Assignee: CONSENG PTY LTD, Australian Capital Territory (AU)

(21) Appl. No.: 14/004,373

(22) PCT Filed: Mar. 12, 2012
(86) PCT No.: PCT/AU2012/000240

§ 371 Date: Nov. 21, 2013

(30) Foreign Application Priority Data
Mar. 10, 2011 (AU) 2011900868

(51) Int. Cl. H04N 7/18

(52) U.S. Cl. CPC H04N 7/183
USPC 348/77

(57) ABSTRACT

A patient monitoring system with image capture functionality, wherein the system is configured such that image data is recorded in response to the sensor signal only if that sensor signal is generated more than a predefined period of time following the identification of a predefined access token. Methods for operating such a system, and computer software/hardware configured to enable the operation and/or configuration of such a system are also disclosed. The embodiments described herein are designed in particular, to assist in protecting a patient against unauthorized persons attempting to interfere with the patient. The system has other management functions such as analyzing fall risk likelihoods, observing patient behavior, improving staff response times, statistical analysis, and ascertaining false alarms

### FIELD OF THE INVENTION

The present invention relates to a patient monitoring system with image capture functionality. Embodiments of the invention have been particularly developed for monitoring activity at or around a patient. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

In many cases, individuals such as patients in a hospital or a nursing home require constant physical care and attention from caregivers. Due to costs and resource limitations there are typically many more patients requiring care than there are caregivers—such as nurses or other health service professionals—in any given organisation. Therefore, it is not always possible to administer personal physical care and support to each and every patient that may warrant such attention. With this in mind, various patient monitoring systems have been developed, these being configured to identify movement proximal of a patient. For example, some bed monitoring systems make use of infrared fields to identify where a patent exits (or attempts to exit) a bed, and/or when another party approaches the bed.

### SUMMARY OF THE INVENTION

It is an object of the present invention to overcome or ameliorate at least one of the disadvantages of the prior art, or to provide a useful alternative.

One embodiment provides a patient monitoring system including:

one or more sensors, wherein each sensor is configured to generate a respective sensor signal in response to movement within a monitored field;

for each senor, a sensor housing configured to position the sensor thereby to situate the monitored field at a predefined position relative to a periphery of a patient container;

an image capture device configured to capture image data, wherein the operation of the image capture device and/or handling of image data captured at the image capture device is controlled responsive to the sensor signals.

One embodiment provides a patient monitoring system including:

a field generator configured to generate a sensor signal in response to movement within a monitored field;

a housing configured to situate the monitored field at a predefined position relative to a periphery of a patient container;

an image capture device contained within the housing, wherein the image capture device is configured to capture image data, wherein the operation of the image capture device and/or handling of image data captured at the image capture device is controlled responsive to the sensor signals.

One embodiment provides a patient monitoring system including:

a field generator configured to generate a sensor signal in response to movement within a monitored field;

a housing configured to situate the monitored field at a predefined position relative to a periphery of a patient container;

an image capture device contained within the housing, wherein the image capture device is configured to capture image data; and

an access control device that is configured to provide an access signal upon identification of a predefined access token;

wherein the system is configured such that image data is recorded in response to the sensor signal only if that sensor signal is generated more than a predefined period of time following the access signal.

One embodiment provides a method for operating a patient monitoring system as described herein.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Embodiments of the invention will now be described, by way of example only, with reference to the accompanying drawing in which:

FIG. 1 schematically illustrates a patient monitoring system according to one embodiment.

FIG. 2 illustrates a method according to one embodiment.

### DETAILED DESCRIPTION

Described herein is a patient monitoring system with image capture functionality, methods for operating such a system, and computer software/hardware configured to enable the operation and/or configuration of such a system. The embodiments described herein are designed in particular, to assist in protecting a patient against unauthorized persons attempting to interfere with the patient. However it has other management functions such as analyzing fall risk likelihoods, observing patient behavior, improving staff response times, statistical analysis, and ascertaining false alarms.

As used herein, the term “patient monitoring system” is used to describe either an individual sensor unit, or a wider system including one or more sensor units and optionally additional components.

As used herein, the term “image data” is used to describe data indicative of images captured at an image capture device. For example, this may include sequential images defining a video sequence.

In overview, the operation of an image capture device and/or handling of image data captured at the image capture device is controlled responsive to sensor signals provided by patient sensing equipment. The patient sensing equipment may include, for example, technology disclosed in any of the following patent applications, which are incorporated by cross reference in their entirety: PCT/AU2004/000135, PCT/AU2007/00191, PCT/AU2008/001324, AU 2009902394, and AU 2010901391.

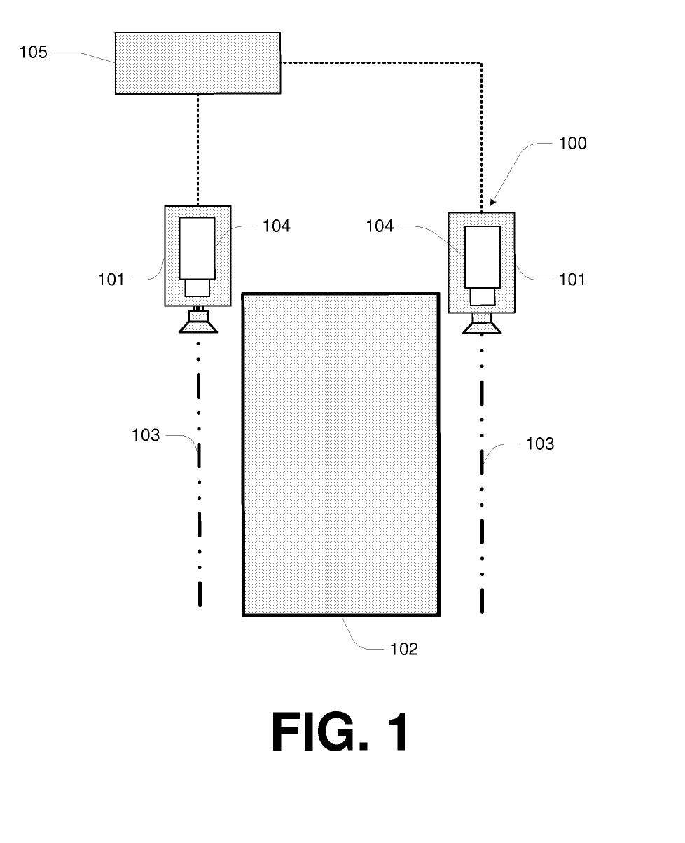

FIG. 1 illustrates a patient monitoring system 100 including a pair of sensor units 101. Other embodiments make use of a single sensor unit, or a greater number of sensor units. The illustrated sensor units are configured for monitoring a bed 102. Specifically, each sensor unit includes a field generator configured to generate a respective sensor signal in response to movement within a monitored field 103. Each sensor unit includes a housing is configured to position the sensor unit thereby to situate the monitored field at a predefined position relative to a periphery of bed 102. The present technology is not, however, limited to beds, and may be applied in respect of other a patient containers (such as chairs, cots, and the like). The sensor housings may be located/mounted in various ways. For example, in some embodiments each sensor housing is built into a wall adjacent a bed location, attached to such a wall by a bracket or the like (enabling transferring of the device between bed locations), built into a bed head, or free standing via a stand (such as a telescopic stand). Other arrangements may also be used.

An image capture device 104 is configured to capture image data. For example, this may include a digital video camera or the like. The camera is configured in terms of positioning to have a field of view including a desired portion of bed 102 (which may include some or all of bed 102). In the illustrated embodiment, an image capture device 104 is mounted in the housing of each sensor and positioned to have a field of view in line with, or substantially in line with, field 103. The camera is preferably a pin-hole type camera, preferably operable at lighting levels of 0.25 lux. In some embodiments infrared type cameras are used, thereby to further improve low-light suitability.

The operation of the image capture device and/or handling of image data captured at the image capture device is controlled responsive to the sensor signals. For example, the image capture device is configured to capture image data in response to an activation signal, this activation signal being defined in response to the sensor signal. In embodiments, this is implemented such that image capture device operates in one or more of the following manners:
Image capture occurs only at times when the sensor signal present.
Image capture is initiated in response to the sensor signal, and continues for a predetermined time.
Recording of captured image data occurs only when the sensor signal is present.
Recording of captured image data is initiated in response to the sensor signal, and continues for a predetermined time.
Device 104 is configured to transmit video data to an external device (such as video device 105), and transmission occurs only at times when the sensor signal present.
Device 104 is configured to transmit video data to an external device (such as video device 105), and transmission is initiated in response to the sensor signal, and continues for a predetermined time

In the illustrated embodiment, device 101 includes an output for delivering image data captured by the image capture device to an external device, in the form of device 105. As noted above, wherein the operation of the output is in some embodiments controlled responsive to the sensor signals. Communication between device 101 and device 105 may include wireless communications.

In the present embodiment device 105 is configured for allowing the viewing and recording of image data captured via device 104. For example, device 105 may include a video server, personal computer, or the like. In some embodiments device 101 is configured to provide additional commands to device 105, for example to control such displaying and/or recording based on sensor signals. Device 105 is preferably coupled to at least one monitor for allowing the display of video data to a viewer.

In some embodiments, device 105 allows for image data for each side of the bed is displayed on a monitor screen at, for example, a nurse station. In some embodiments a number of beds requiring attention is additionally displayed on this monitor (for example device 105 receives a signal from each sensor unit based on the sensor signal indicating that a bed requires attention). This display optionally includes time, date, patient name and bed location. Furthermore, the screen is coupled to an input device such that a nurse or other user may access image data from the image capture devices that monitor a desired bed.

In some embodiments an access control device is configured to provide an access signal in response to the presentation of a predefined token. For example, this may be a proximity based access control device (such as an object, such as a card, carrying a RFID chip or the like).

The access signal affects the operation of the image capture device and/or handling of image data captured at the image capture device. For example, in some embodiments the access control device allows identification of an authorized party approaching bed 102, and image data is handled accordingly. For example, in some cases capture and/or recording is limited to non-authorized breaches of fields 103. In one embodiment the system is configured such that image data is recorded in response to the sensor signal only if that sensor signal is generated more than a predefined period of time following the access signal.

Embodiments additionally include methods for operating a patient monitoring system as discussed herein, and computer software for implementing such methods.

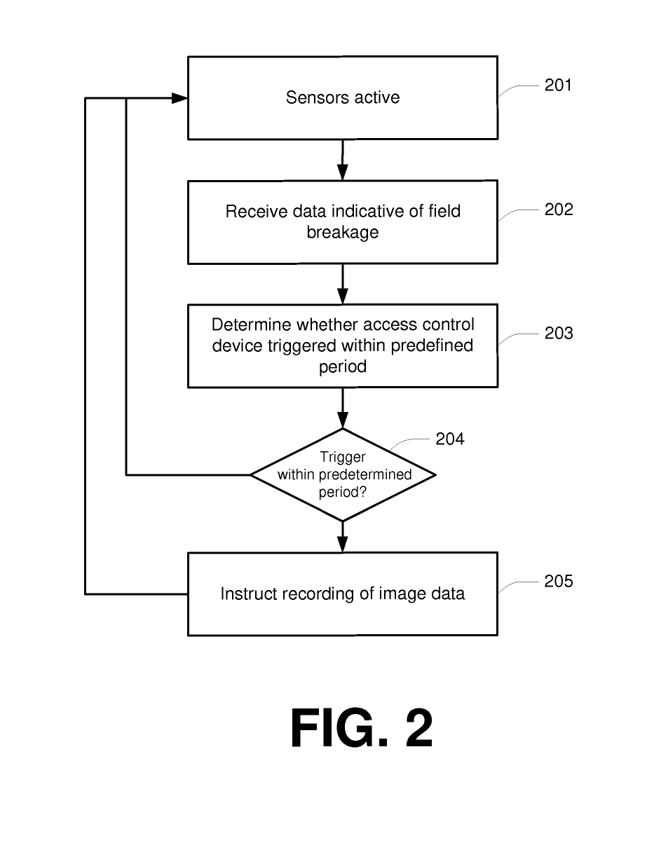

FIG. 2 illustrates an exemplary method for operating a monitoring system, according to one embodiment. This method may be performed based on the execution of software instructions (i.e. computer readable code stored on a carrier medium) via one or more microprocessors. Functional block 201 represents a state in which sensors are active, including a field generator configured to generate a sensor signal in response to movement within a monitored field, and an access control device that is configured to provide an access signal upon identification of a predefined access token. Functional block 202 represents receipt of a signal from the field generator indicating that the monitored field has been broken (i.e. movement in the field). Functional block 203 includes determining whether the access control device has been triggered (by presentation of a valid access token) within a predefined period. For example, in some hardware arrangements an access control device adopts an “access grant” state for a predefined period following identification of a valid token, and block 203 includes looking for the “access grant” state. The outcome of this process feeds into decision 204. In the case that there has been a trigger in the predetermined period, the method loops to 201, and no recording is made. If there has been no such trigger, the method continues to 205, and a recording is made.

It will be appreciated that other embodiments make use of variations to the method of FIG. 2 thereby to achieve a corresponding functionality. For example, one alternative approach includes disabling the field generator for a predetermined time following the access signal.

It will be appreciated that the disclosure above provides various significant systems and methods for monitoring patients. While there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1-11. (canceled)

12. A patient monitoring system including:
a field generator configured to generate a sensor signal in response to movement within a monitored field;
a housing configured to situate the monitored field at a predefined position relative to a periphery of a patient container;
an image capture device contained within the housing, wherein the image capture device is configured to capture image data; and
an access control device that is configured to provide an access signal upon identification of a predefined access token,
wherein the system is configured such that image data is recorded in response to the sensor signal only if that sensor signal is generated more than a predefined period of time following the access signal.

13. The system according to claim 12 wherein the image capture device is configured to capture image data in response to an activation signal.

14. The system according to claim 13 wherein the activation signal is defined in response to the sensor signal.

15. The system according to claim 12 including an output for delivering image data captured by the image capture device to an external device, wherein the operation of the output is controlled responsive to the sensor signals.

16. The system according to claim 12 including an access control device, wherein an access control device is configured to provide an access signal in response to the presentation of a predefined token, and wherein the access signal affects the operation of the image capture device and/or handling of image data captured at the image capture device.

17. A patient monitoring system including:
a field generator configured to generate a sensor signal in response to movement within a monitored field;
a housing configured to situate the monitored field at a predefined position relative to a periphery of a patient container; and
an image capture device contained within the housing, wherein the image capture device is configured to capture image data,
wherein the operation of the image capture device and/or handling of image data captured at the image capture device is controlled responsive to the sensor signals.

18. The system according to claim 17 wherein the image capture device is configured to capture image data in response to an activation signal.

19. The system according to claim 16 wherein the activation signal is defined in response to the sensor signal.

20. The system according to claim 17 including an output for delivering image data captured by the image capture device to an external device, wherein the operation of the output is controlled responsive to the sensor signals.

21. The system according to claim 17 including an access control device, wherein an access control device is configured to provide an access signal in response to the presentation of a predefined token, and wherein the access signal affects the operation of the image capture device and/or handling of image data captured at the image capture device.

22. A patient monitoring system including:
one or more sensor units, wherein each sensor is configured to generate a respective sensor signal in response to movement within a monitored field;
for each senor, a sensor housing configured to position the sensor thereby to situate the monitored field at a predefined position relative to a periphery of a patient container; and
an image capture device configured to capture image data, wherein the operation of the image capture device and/or handling of image data captured at the image capture device is controlled responsive to the sensor signals.

23. A method for operating a patient monitoring system according to claim 12.

24. A computer program configured to perform a method according to claim 23.

25. A non-transitive carrier medium carrying computer executable code that, when executed on a processor, causes the processor to perform a method according to claim 23.

26. A method for operating a patient monitoring system according to claim 17.

27. A computer program configured to perform a method according to claim 26.

28. A non-transitive carrier medium carrying computer executable code that, when executed on a processor, causes the processor to perform a method according to claim 26.
